(19) United States
(12) Patent Application Publication
(10) Pub. No.: US 2005/0195743 A1
(43) Pub. Date: Sep. 8, 2005

(54) Real time charging of pre-paid accounts

(75) Inventors: Haim Rochberger, Tel-Mond (IL); Meir Morgenstern, Tel-Aviv (IL); Dror Sneh, Sunnyvale, CA (US); Genny Dosovitsky, Sunnyvale, CA (US); Ravid Sagy, Palo Alto, CA (US)

Correspondence Address: SUGHRUE MION, PLLC, 2100 PENNSYLVANIA AVENUE, N.W., SUITE 800, WASHINGTON, DC, 20037, US

(73) Assignee: P-CUBE LTD.

(21) Appl. No.: 10/945,887

(22) Filed: Sep. 22, 2004

Related U.S. Application Data
(63) Continuation-in-part of application No. 09/541,598, filed on Apr. 3, 2000, now Pat. No. 6,831,893.
(60) Provisional application No. 60/506,171, filed on Sep. 29, 2003.

(51) Int. Cl. H04L 12/26

(52) U.S. Cl. 370/235

(57) ABSTRACT

An apparatus for charging a network subscriber's prepaid network usage account in real time. The apparatus has a service engine, a service manager and a quota manager. The service engine is operable to analyze network traffic flow through the apparatus and to identify a network transaction corresponding to the account. The service engine is further operable to determine a usage quota for the subscriber. The service manager is operable to maintain information related to the subscriber and the account. The quota manager is operable to communicate with an external prepaid server.

This application is a Continuation-in-Part of application Ser. No. 09/541,598 by Ben-Nun et al. entitled “An Apparatus for Wire-Speed Classification and Pre-Processing of Data Packets in a Full Duplex Network” and filed Apr. 3, 2000, the entirety of which is incorporated herein by reference. The present application also claims priority from U.S. Provisional Patent Application No. 60/506,171, submitted Sep. 29, 2003, which is incorporated herein by reference.

### I. DESCRIPTION

I.A. Field

The disclosed teachings relate generally to network communications systems, and more particularly to techniques for billing prepaid chargeable services.

I.B. Background

1. References

The following U.S. patents and papers provide useful background information, for which they are incorporated herein by reference in their entirety.

| | | |
|---|---|---|
| 09/541,598 | April 2000 | Ben Nun, et al. |
| 09/547,034 | April 2000 | Ben Nun, et al. |
| 09/789,562 | August 2002 | Gonthier, et al. |
| 10/120,790 | January 2003 | Uwe, et al. |
| 10/358,359 | August 2003 | Ghys |

2. Introduction

Current networking systems continue to facilitate ease of information transfer and convenience to users. The explosion of local, regional, and global networks such as the Internet has provided significant quantity of information to the consuming public. These networking technologies have expanded to increasingly include wireless and mobile technologies. Information can be downloaded to desktop, wireless, and mobile systems, through a variety of interconnected networks. For instance, information available through the Internet can be downloaded onto mobile wireless units, such as cellular telephones, personal digital assistants (PDAs), laptop computers, and the like.

Access to information is obtained using access technologies, such as general packet radio service (GPRS), universal mobile telecommunications system (UMTS), 802.11 based wireless, etc. These access technologies further provide subscribers with an unprecedented variety of new services based on the subscriber's location, selected content, and the personal preferences. It is generally known that charges for such services are postpaid or prepaid. Charges on prepaid usage accounts are then deducted from the usage accounts.

Prepaid solutions allow a subscriber to pay for usage of a system in advance. The subscriber has an account with a certain amount of credit. This credit is available, for example, for a certain connection time, a certain amount of transferred information, access to certain services, and bandwidth consumption, etc. Whenever the user uses the system and performs actions that deplete his credit, the credit is decreased. If the user is only debited for transferred information, he may stay connected infinitely without being debited. Once the credit goes down to zero, or a validity period for the credit has expired, the subscriber should no longer be able to use the credit to access the system until more credit is added to the account.

Related art solutions provide a prepaid server that accounts the billable actions and calculates the remaining credit. In order to create charging records, a prepaid server interfaces with each content server to get information on subscribers' usage. A traditional prepaid server is not considered a network component, and therefore is not capable of performing these charging actions as well as controlling the traffic flowing through the network in real time. Specifically, prepaid servers cannot deliver the service requested by the subscriber. The result is loss of revenue to service providers. For example, during the delay periods between a query and an answer the corresponding account may not only be fully depleted but may already be in the negative.

### II. BRIEF DESCRIPTION OF THE DRAWINGS

The disclosed teachings will become more apparent by describing in detail, implementations of the techniques discussed herein with reference to the attached drawings in which:

FIG. 1 shows an exemplary network system including a prepaid charging RTPC apparatus embodying aspects of the disclosed teachings.

FIG. 2 shows a non-limiting list of chargeable services supported by the RTPC apparatus according to the present invention

FIG. 3 shows a non-limiting set of templates according to some aspects of the disclosed teachings.

FIG. 4 provides a detailed block diagram of an exemplary real time charging RTPC apparatus embodying aspects of the disclosed teachings.

FIG. 5 shows an exemplary non-limiting process flow illustrating techniques for providing prepaid network access embodying aspects of the disclosed teachings.

FIG. 6 shows an exemplary non-limiting flow chart illustrating techniques for charging embodying aspects of the disclosed teachings.

### III. SUMMARY

To overcome some of the problems noted above, the disclosed teachings provide an apparatus for charging a network subscriber's prepaid network usage account in real time. The apparatus has a service engine, a service manager and a quota manager. The service engine is operable to analyze network traffic flow through the apparatus and to identify a network transaction corresponding to the account. The service engine is further operable to determine a usage quota for the subscriber. The service manager is operable to maintain information related to the subscriber and the account. The quota manager is operable to communicate with an external prepaid server.

In another specific enhancement, the apparatus includes a rating engine operable to provide said service engine with a plurality of rating functions.

In another specific enhancement, apparatus is a network component connected to an access server and an Internet protocol (IP) network through at least a fast Ethernet link.

More specifically, the subscriber communicates with said access server using an IP capable terminal through a wireless access network.

More specifically, the wireless access network comprises at least one of: general packet radio service (GPRS), GSM, code division multiple access (CDMA), time division multiple access (TDMA), 802.11 based network, Bluetooth.

In another specific enhancement, the service engine is operable to analyze traffic flow at wire-speed.

More specifically, said network transaction comprises a process flow.

More specifically, the process flow is identified by a unique process identification dependent on at least one of: source IP address, destination IP address, source port, destination port, protocol type.

More specifically, the service engine is operable to identify packets flowing both upstream and downstream over the network as belonging to the process flow.

In another specific enhancement, the subscriber's network transaction is a billable action defined according to a service requested by the subscriber.

More specifically, the billable action is charged according to a predetermined rating function.

More specifically, the service is at least one of: browsing, streaming, downloading, instance messaging, email exchange, gaming, voice over IP (VoIP) and peer-to-peer connection.

More specifically, the service is defined using a set of attributes and a set of measurement units.

More specifically, the attributes comprise at least one of: protocol type, application type, IP address, port name, hostname, universal resource locator (URL) and type of content.

More specifically, the protocol type comprises at least one of:
hypertext transfer protocol (HTTP), file transfer protocol (FTP), wireless application protocol (WAP), post office protocol version 3 (POP3) and simple mail transfer protocol (SMTP).

More specifically, the measurement units comprise at least one of: volume of traffic, duration of a connection and allocated bandwidth.

In another specific enhancement, the service engine is further operable to control the network transaction.

More specifically, the network transaction comprises at least one of the following actions: blocking said network transaction, redirecting said network transaction and rate throttling of said network transaction.

In another specific enhancement, said service engine is operable to calculate the usage quota at wire-speed.

More specifically, said service engine is operable to calculate the usage quota using a rating function.

In another specific enhancement, the apparatus is operable to receive a first login event generator notification upon the subscriber's authentication, the prepaid server is operable to provide a profile and an account quota for the subscriber, the apparatus is further operable to allow the subscriber to access a requested service if the quota is sufficient for the requested service; and the apparatus is further operable to calculate a remaining credit for said account after the network transaction.

More specifically, the apparatus is operable to update said PPS with the remaining credit upon receiving a second login event generator (LEG) notification indicating the subscriber logging out.

More specifically, the remaining credit is maintained by said quota manager.

More specifically, the first LEG notification and the second LEG notification are sent from an authentication, authorization and accounting server.

More specifically, the service manager is operable to receive the first LEG notification and the second LEG notification.

More specifically, at least one of the first LEG notification and the second LEG notification includes a subscriber identification number.

More specifically, the predetermined preventive action comprises at least one of: blocking said network transaction, redirecting said network transaction and throttling said network transaction.

Another aspect of the disclosed teachings is a method for charging a subscriber's prepaid network usage account in real time, the method comprises receiving a first login event generator (LEG) notification for the subscriber authentication. A prepaid profile of the subscriber is obtained from a prepaid server. A new incoming subscriber network transaction is mapped to a requested service. A quota is obtained for the prepaid usage account from the prepaid server. The subscriber is allowed to access the requested service if the quota is sufficient. A first predetermined preventive action on the network transaction is performed if the quota is not sufficient. A remaining credit for the prepaid usage account is determined after the network transaction. If the remaining credit reaches a limit, a second predetermined preventing action is applied on subsequent transaction networks.

In another specific enhancement, the prepaid server is updated with the remaining credit upon receiving a second LEG notification that notifies that the subscriber has logged out.

Another aspect of the disclosed teachings is a computer program product including a computer readable medium that comprises instructions to enable a computer to implement the above methods.

### IV. DETAILED DESCRIPTION

The disclosed teachings provide a real-time prepaid charging apparatus (hereinafter the “RTPC” apparatus) and techniques for performing real time billing of prepaid data transactions, in a communication network. The RTPC apparatus is a network element that monitors and controls the traffic flowing through the network. Furthermore, the RTPC apparatus manages the subscribers' prepaid usage accounts and the reserved credit for the subscriber's usage.

In an exemplary non-limiting implementation, the RTPC apparatus is capable of monitoring network traffic in the application layer (i.e., the seventh layer) of the seven-layer communication model. Such monitoring capabilities are described in U.S. patent application Ser. No. 09/541,598 (hereinafter the “'598 application”) entitled “An Apparatus for Wire-Speed Classification and Pre-Processing of Data Packets in a Full Duplex Network” and in U.S. patent application Ser. No. 09/547,034 (hereinafter the “'304 application”) entitled “A Method and Apparatus for Wire-Speed Application Layer Classification of Data Packets”. The '598 application '034 application are both assigned to common assignee and incorporated herein by reference for all that they contain.

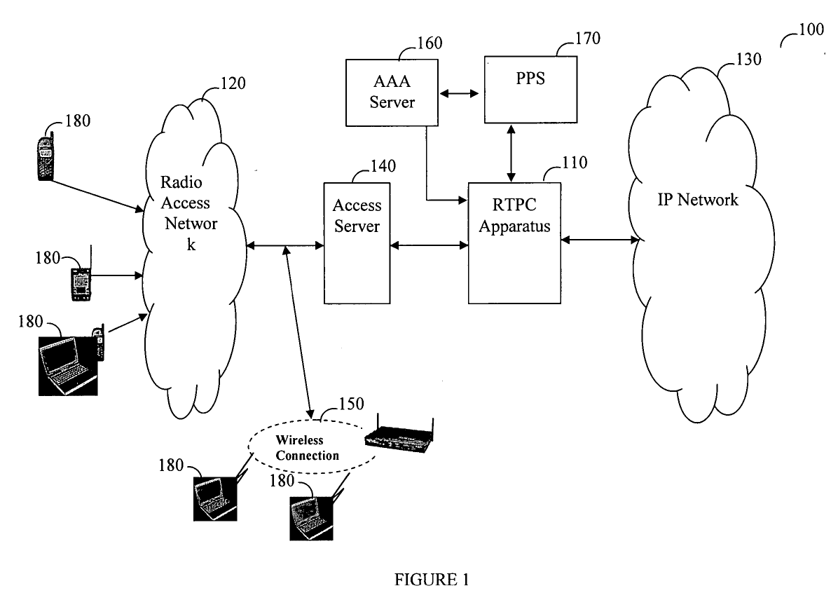

FIG. 1 shows an exemplary network system 100 that embodies aspects of the disclosed teachings. Network system 100 includes an RTPC apparatus 110, a radio access network 120, an Internet protocol (IP) network 130, an access server 140, a wireless connection 150, an authentication, authorization and accounting (AAA) server 160, a prepaid system (PPS) 170, and a plurality of IP capable terminals 180. The wireless terminal 180 is an IP capable terminal including, but not limited to, a mobile phone, a PDA, a wireless modem, a personal computer (PC), and so on.

The wireless connection 150 is a wireless network. An exemplary implementation could be based on the IEEE 802.11 standard, Bluetooth, or infrared. A person skilled-in-the-art would note that the wireless systems shown are exemplary, and other such wireless networks and access points may be added in a similar manner.

A subscriber accesses the IP network 130 using a terminal with a prepaid usage account registered both in terminal 180 and in PPS 170. A terminal 180 includes capability for keeping prepaid usage account data, such as storage space on terminal 180, a prepaid card, an insert-able non-volatile memory device, and others. The usage account data includes a subscriber (account) identifier (e.g., a subscriber's phone number) a network access identifier (NAI), a password, or other information identifying the subscriber. PPS 170 holds and manages subscribers' prepaid profiles, each prepaid profile includes at least the subscriber identifier, type of services that can be accessed by the subscriber, and rating information, i.e., the criteria according to which the account is to be charged.

A subscriber may access IP network 130 using terminal 180 through radio access network 120 and access server 140. Radio access network may be a GPRS, GSM, CDMA, TDMA, or any other wireless access network. The type of access server 140 depends on the type of radio access network 120, for example, access server 140 is a gateway GPRS serving node (GGSN) for GPRS networks.

RTPC apparatus 110 is a network component located in the path between IP network 130 and access server 140. RTPC apparatus 110 analyzes the IP traffic in real-time (i.e., at wire speed) to determine the type of service requested by the subscriber. Specifically, for a given network session RTPC apparatus 110 maps the traffic to a specific service. A service is defined as the classification of a subscriber's network transaction or transactions based on network parameters and attributes corresponding to layer three through layer seven. These attributes are used for implementing different policy rules. Service may be defined by using a plurality of different attributes including, but not limited to, type of protocol (e.g., HTTP, FTP, WAP, POP3, SMTP, and so on.) that is used, type of applications that are used, destination addresses (e.g., IP address, port name, hostname, URL, and so on), type of content, or any other attributes of the protocols and applications that are used. The type of a service also determines the measurement units for each billable transaction. The measurement units may be volume of traffic (e.g., the amount of bytes transferred), the duration of the connection (e.g., the actual time the connection was alive), the allocated bandwidth (e.g., the number of bytes per second transferred), or any measurement units defined by the service provider.

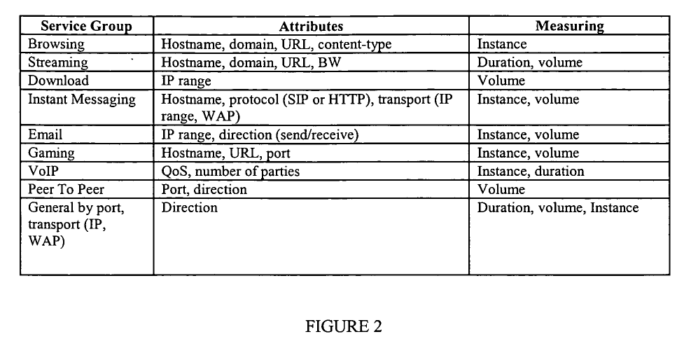

FIG. 2 shows a non-limiting list of services classified by RTPC apparatus 110, the attributes that define each service, and the measurement units for each service. Furthermore, the service provider may define a service based on a set of attributes that are not part of the standard protocols, e.g., port-based protocols. The protocols are mapped to templates, where each template defines a different type of service. These protocols could be standard or user-defined. The use of templates significantly simplifies the process of creating and defining services and reduces the time required to identify the type of requested service.

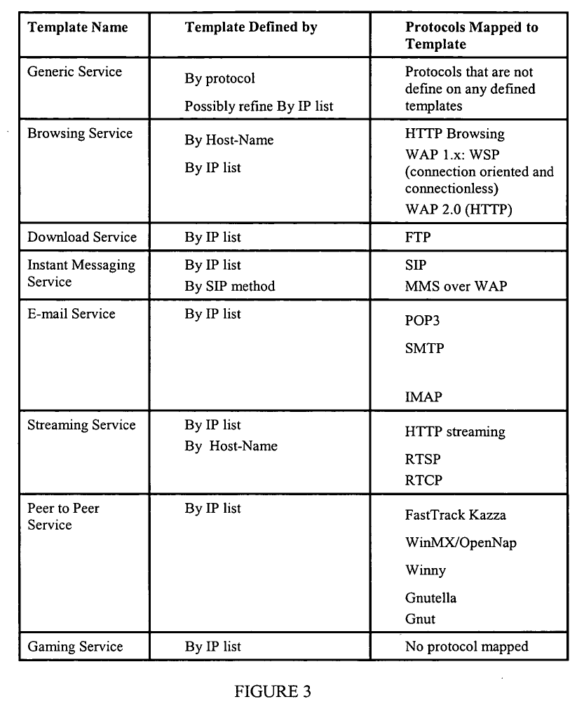

An exemplary and non-limiting list of templates defined in RTPC apparatus 110 is shown in FIG. 3. It is noteworthy that a purpose of having a template is to simplify the configuration of services, without limiting the operator from defining a new template that, for example, overrides predefined templates. The creation of new templates allows for the creation of services that are unique to a specific operator providing such an operator with a competitive edge. For example, a predefined template “mail” is by default mapped to protocols like IMAP4, POP3, and SMTP, and template “streaming” is by default mapped to protocols like RTCP, and RTSP.

An operator may wish to define a new template “my-template” that takes SMTP and RTSP from the above templates and maps them to “my-template”. In this case it is the operator's responsibility to make sure the flavor (like URL, destination IP address range, etc) that is used under that template is applicable for those protocols.

RTPC apparatus 110 also controls the traffic originating from and flowing to IP network 130 and terminals 180. Specifically, apparatus 110 may block, redirect, or throttle the traffic if the subscriber's credit has expired. For this purpose, RTPC apparatus 110 maintains and manages subscriber information for each subscriber. The subscriber information may be pre-configured by the service provider or dynamically configured by the AAA server 160. RTPC apparatus 110 is further capable of managing the credit of each subscriber without latency by providing PPS 170 with the reserved credit after each transaction or when the subscriber's session ends.

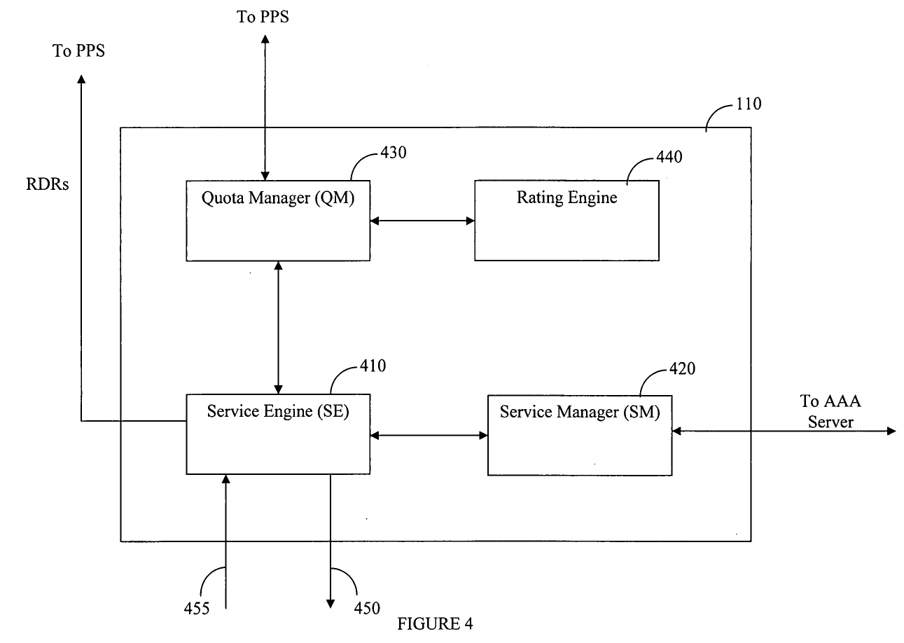

A transaction is a predefined billable action as defined by the service template, where each billable action is charged according to a predetermined rating function. Example for billable actions are, but are not limited to: FTP file download, HTTP browsing, or a multimedia messaging service (MMS) message sent to another subscriber. A detailed block diagram of an exemplary non-limiting RTPC apparatus 110 is provided with reference to FIG. 4.

AAA server 160 is responsible for performing the activities of authentication, authorization, and accounting in system 100. Specifically, the AAA server 160 sends a first login event generator (LEG) notification to the RTPC apparatus 110 upon subscriber authentication and a second LEG notification once a subscriber is logged out. The notification includes subscriber attributes, such as subscriber identifier and subscriber network address. LEG notification is only one approach to inform RTPC apparatus 110 on the subscriber's authentication and many other implementations will be easily recognized by those skilled in the art.

FIG. 4 shows a detailed block diagram of an exemplary non-limiting RTPC apparatus 110 embodying aspects of the disclosed teachings. The RTPC apparatus 110 includes a service engine (SE) 410, a subscriber manager (SM) 420, a quota manager (QM) 430, and optionally a rating engine 440. RTPC apparatus 110 connects to the IP network 130 and the access server 140 through fast Ethernet (GB Ethernet) connections 450 and 455. An exemplary but non limiting implementation of the SE 410 is described in the '598 application the '034 application.

SE 410 is responsible for executing all activates related to analyzing and controlling the traffic flow transmitted through RTPC apparatus 110. These activities are performed in real-time and at a wire-speed. For the traffic flow through SE 410 it identifies network transactions associated with a subscriber requesting a service. A network transaction includes at least one process flow having unique process flow identification. One process flow may be differentiated from another process flow based on the header information of a packet that typically identifies one or more of the following elements of the packet header: source IP, a destination IP, a source port, a destination port, and a protocol type. It should be noted that a traffic flow comprises a plurality of packets following upstream and downstream through RTPC apparatus 110, while a subscriber's network transaction comprises only of those packets corresponding to the usage of a specific subscriber, regardless of the direction of flow of such packets, i.e., regardless of the packet flow in an upstream direction or a downstream direction. SE 410 is further capable of associating packets with a process flow common to a plurality of packets. In addition, when the incoming traffic flow includes a subscriber's new network transaction, SE 410 maps the network transaction to a service and informs SM 420 that a service from a new subscriber was requested. In some cases SE 410 may apply predefined actions on the incoming traffic. For example, SE 410 may block, redirect, and throttle the traffic rate if the subscriber's credit has expired. The action to be taken is determined according to the type of service and the subscriber's prepaid profile. In one embodiment, SE 410 communicates with QM 430 and PPS 170 by exchanging RDR messages. The RDR messages include information about the network transactions, subscribers, traffic usage, and general information identifying the messages.

SM 420 maintains for each subscriber, the information related to the subscriber. The subscriber information includes the subscriber identifier (e.g., phone number), services that can be accessed by the subscriber, the allocated IP address, the subscriber network address, and so on. The subscriber's information may be static information (i.e., preconfigured) or dynamic information (i.e., information provided by AAA server 160). For instance, as a subscriber logs on, AAA server 160 authenticates the subscriber, allocates a dynamic IP address for the session, associates the allocated IP address and the subscriber ID, and sends the mapping of the allocated IP address and subscriber ID to SE 410. SE 410 uses this mapping information for further processing network transactions from or to the subscriber and for interacting with PPS 170. Additionally, SM 420 may retrieve a subscriber policy profile from an external third party application located in PPS 170. An example for such third party application is an account management/billing application that maintains a database with information about prepaid subscribers. In such a case, SM 420 establishes connection with the external application system using an application-programming interface (API) supported by external the application.

QM 430 acts as interface between SE 410 and PPS 170. QM 430 receives requests for credit and charging from SE 410 using a proprietary protocol and forwards these requests to PPS 170. QM 430 further adapts these requests to the specific protocol format supported by PPS 170. The protocol used for communication between PPS 170 and QM 430 may be, but is not limited to the Parlay, Diameter's CCA, and the like. The use of the Parlay API allows smooth and simple integration with PPS 170, i.e., the integration with PPS 170 does not require any modifications in RTPC apparatus 110.

SE 410 performs activities related to calculation of the credit remaining, for a logged-on subscriber, after a subscriber's network transaction is served. Specifically, SE 410 operates in three different charging modes: simple charging, real-time charging, and smart charging. In the simple charging mode, for each transaction, SE 410 sends to the PPS 170 the network transaction that was performed by the subscriber. Based on the transaction information and the rating function of the transaction, PPS 170 authorizes the transaction and charges for the transaction, otherwise the transaction is denied. This process is repeated for each transaction reported by SE 410. In the real-time charging mode, SE 410 receives, via the QM 430, from PPS 170 the subscriber's credit and after each transaction or after a predefined number of transactions calculates the remaining credit.

When the subscriber logs out, SE 410 sends to PPS 170 the remaining credit and reports the charging based on usage. It should be noted that, if the remaining credit is close to depletion during the subscriber's session, then SE 410 requests for new credit. The real-time charging mode allows managing the subscriber's quota without latency. In the smart charging mode, the same activities are performed as in the real-time charging mode. However, in this mode SE 410 is configured with rating functions that determine how to convert network units to monetary value. The rating functions may be defined to designated services or to a group of services that may use the same rating function and the same credit.

For example, the credit received from PPS 170 is 100 dollars and there are two services that can use this credit: a browsing service and an immediate messaging service. The browsing service is charged according to the consumed bandwidth with a rate function defined as: 1 Kbps equals 1 dollar. The immediate messaging service is charged according to the number of transmitted messages with a rate function of: 1 message equals 1 dollar. For this configuration, SE 410 calculates and reduces the amount of money consumed by these two services without requesting from PPS 170 two credit chunks each per service.

In accordance with an exemplary implementation embodying aspects of the disclosed teachings, the RTPC apparatus 110 may include a rating engine 440 that provides the rating functions. A rating function determines how to calculate the cost of transactions based on their traffic parameters, e.g., destination IP, time-of-day, duration, quality of service (QoS), and so on. The rating function may be a simple function, e.g., a linear rating or a complicated function, e.g., functions based on historical usage. The components of RTPC apparatus 110 may be hardware components, software components, firmware components, or any combination thereof.

It should be appreciated by a person skilled in the art that an advantage of some aspects of the disclosed teachings is the ability to analyze the traffic flow and especially identifying the type of service at wire-speed. Specifically, the disclosed RTPC apparatus 110 is capable of identifying process flow correlated with a single subscriber for packets flowing in both the upstream and downstream directions. The disclosed teachings provide the capability for supplier to charge a subscriber for the actual traffic usage of the network bandwidth, for both traffic transmitted from IP network 130 to terminal 180 and vice versa. It further provides the capability to do real time charging of the subscriber's prepaid credit and hence avoids overdraw of network bandwidth associated with prior art solutions that require validations through a central control system.

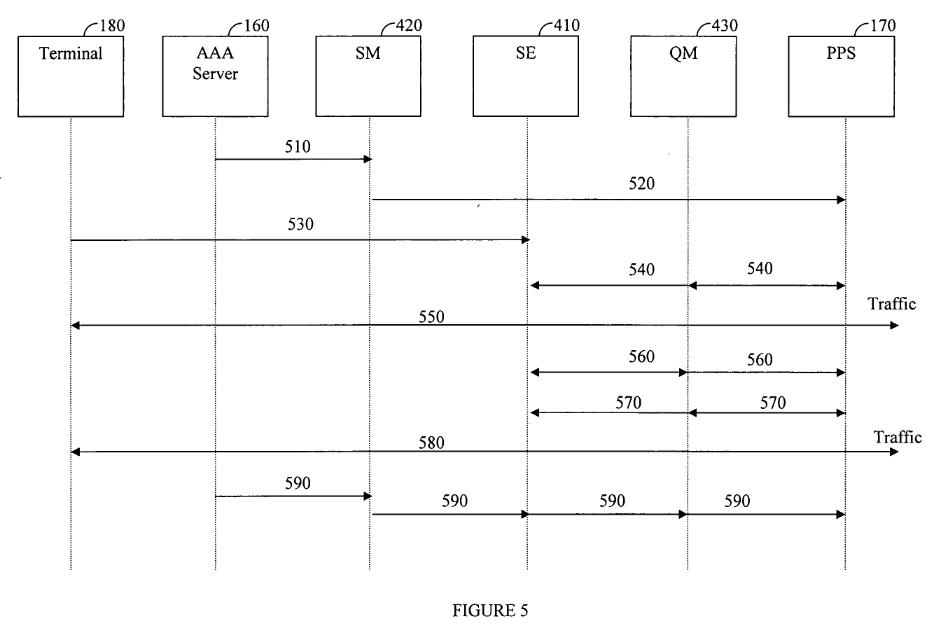

FIG. 5 shows an exemplary letter diagram describing the operation of RTPC apparatus 110. At step 510, as a subscriber tries to access IP network 130 using terminal 180, the AAA server 160 sends a LEG notification to SM 420 upon the subscriber authentication. The LEG notification includes the subscriber attributes, such as subscriber identification mapped to subscriber network address. At step 520, SM 420 extracts the subscriber attributes from the received LEG notification and requests from PPS 170 the subscriber's prepaid profile. The prepaid profile is a set of rules defines the subscriber's permission for all services defined in SE 410. A rule may define how to treat a specific service or group of services (i.e., a default profile) requested by the user. A profile is associated with a subscriber and can be changed at any time upon the subscriber demand. For example, a “Silver Profile” may permit the subscriber to access only HTTP browsing services, while a “Gold Profile” may permit the subscriber to access all the services defined in RTPC apparatus 110. The user may upgrade its profile from Silver to Gold through the service provider. SE 410 maintains the subscriber attributes and the prepaid profile during the entire session. At step 530, upon identifying a new network transaction, SE 410 opens new session and maps the new network transaction to a requested service. In addition, SE 410 determines the measurement units for the requested service (e.g., volume, time, instances) and the “start action” rule for the requested service. For example, the transaction action may be to block the subscriber from using the requested service, if or when the subscriber is not authorized to access this service. At step 540, SE 410 gets the subscriber's credit from PPS 170 using QM 430. If the subscriber's credit is insufficient, then SE 410 handles the network transaction according to the subscriber's profile. For example, SE 410 may block, redirect, or throttle the network transaction. At step 550, SE 410 allows the subscriber to use the service while consuming the credit. At step 560, while the subscriber uses the services, SE 410 together with QM 430 charges the consumed credit. At step 570, SE 410 requests from PPS 170 the reserved credit. At step 580, SE 410 allows traffic consumption if the subscriber reserved credit is not expired. At step 590, as the subscriber logs out, AAA server 160 sends a LEG notification to SM 420 indicating on a logout event. SM 420 propagates the LEG notification event to SE 410. As a result, QM 430 releases the remaining credit in SE 410 and notifies PPS 170 about the charging.

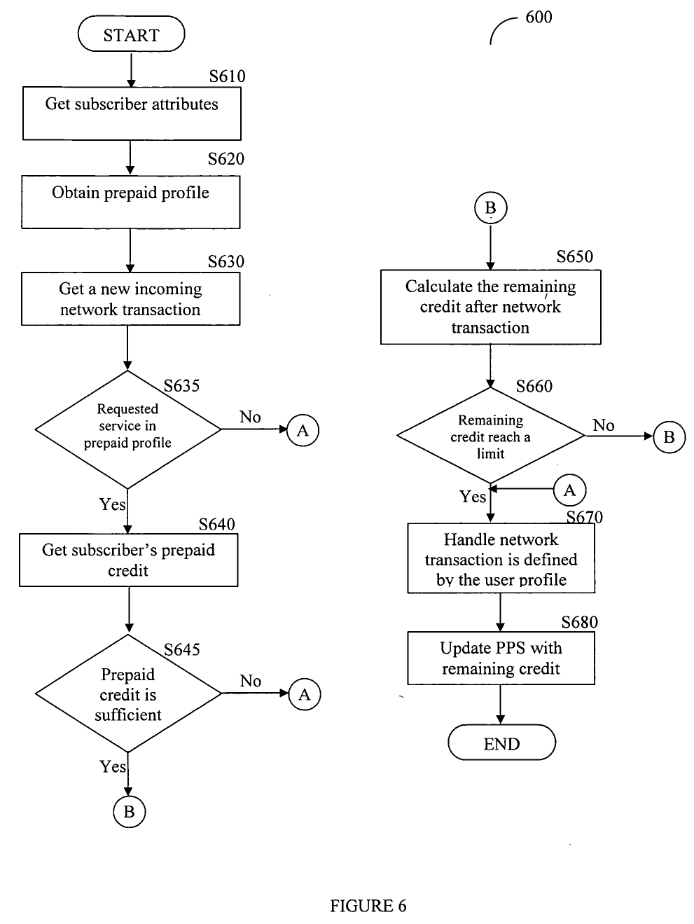

FIG. 6 shows a non-limiting flowchart 600 illustrating an exemplary implementation of repaid charging embodying aspects of the disclosed teachings. In step S610, the subscriber attributes including his identification and network address are received at RTPC apparatus 110. In step 5620 the prepaid profile of is obtained. The profile includes a set of rules defining the permission for services requested by the subscriber. In step S630, a new subscriber network transaction is received, and thereafter network session is established between the subscriber terminal and the IP network and the measure units for the service requested in the transaction are determined. In step S635, a check to determine if the subscriber's network transaction includes a service defined in the prepaid profile and if so execution continues with step S640; otherwise, execution continues with step S670. In step S640, the subscriber's prepaid credit in the subscriber account is obtained from the PPS. In step S645, another check is made to determine if the prepaid credit of the subscriber attempting to use the network services is sufficient to serve the service requested by the subscriber, and if so execution continues with step S640; otherwise, execution continues with step S670. In step S650, for each received network transaction (i.e., billable action) the subscriber account is charged, i.e., the remaining credit is calculated. Specifically, the charging is performed according to a predetermined charging mode, i.e., a simple charging, real-time charging, and smart charging described in greater detail above. It should be noted that billing subscribers as transaction networks received eliminates the shortcomings of prior-art solutions where the delay periods between a query and an answer the PPS of charging may be not only fully depleted but may be already in the negative. In step S660, a check is made to determine if the remaining credit reaches a limit, and if so execution continues with step S670 where the network transaction are handled according to the determine in the subscriber profile; otherwise, execution continues with step S650. In step S680, once the subscriber logs out, the reaming calculated is sent the PPS.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

1. An apparatus for charging a network subscriber's prepaid network usage account in real time, said apparatus comprising:
a service engine operable to analyze network traffic flow through the apparatus and to identify a network transaction corresponding to the account, said service engine further operable to determine a usage quota for the subscriber;
a service manager operable to maintain information related to the subscriber and the account; and,
a quota manager operable to communicate with an external prepaid server (PPS).

2. The apparatus of claim 1, further comprising a rating engine operable to provide said service engine with a plurality of rating functions.

3. The apparatus of claim 1, wherein said apparatus is a network component connected to an access server and an Internet protocol (IP) network through at least a fast Ethernet link.

4. The apparatus of claim 3, wherein the subscriber communicates with said access server using an IP capable terminal through a wireless access network.

5. The apparatus of claim 4, wherein said wireless access network comprises at least one of: general packet radio service (GPRS), GSM, code division multiple access (CDMA), time division multiple access (TDMA), 802.11 based network and Bluetooth.

6. The apparatus of claim 1, wherein the service engine is operable to analyze traffic flow at wire-speed.

7. The apparatus of claim 6, wherein said network transaction comprises a process flow.

8. The apparatus of claim 7, wherein said process flow is identified by a unique process identification dependent on at least one of: source IP address, destination IP address, source port, destination port, protocol type.

9. The apparatus of claim 8, wherein the service engine is operable to identify packets flowing both upstream and downstream over the network as belonging to the process flow.

10. The apparatus of claim 1, wherein the subscriber's network transaction is a billable action defined according to a service requested by the subscriber.

11. The apparatus of claim 10, wherein said billable action is charged according to a predetermined rating function.

12. The apparatus of claim 10, wherein said service is at least one of: browsing, streaming, downloading, instance messaging, email exchange, gaming, voice over IP (VoIP) and peer-to-peer connection.

13. The apparatus of claim 12, wherein said service is defined using a set of attributes and a set of measurement units.

14. The apparatus of claim 13, wherein said attributes comprise at least one of: protocol type, application type, IP address, port name, hostname, universal resource locator (URL) and type of content.

15. The apparatus of claim 14, wherein said protocol type comprises at least one of: hypertext transfer protocol (HTTP), file transfer protocol (FTP), wireless application protocol (WAP), post office protocol version 3 (POP3) and simple mail transfer protocol (SMTP).

16. The apparatus of claim 13, wherein said measurement units comprise at least one of: volume of traffic, duration of a connection and allocated bandwidth.

17. The apparatus of claim 1, wherein said service engine is further operable to control the network transaction.

18. The apparatus of claim 17, wherein controlling the network transaction comprises at least one of the following actions: blocking said network transaction, redirecting said network transaction and rate throttling of said network transaction.

19. The apparatus of claim 1, wherein said service engine is operable to calculate the usage quota at wire-speed.

20. The apparatus of claim 19, wherein said service engine is operable to calculate the usage quota using a rating function.

21. The apparatus of claim 1, wherein
said apparatus is operable to receive a first login event generator (LEG) notification upon the subscriber's authentication,
said prepaid server is operable to provide a profile and an account quota for the subscriber;
said apparatus is further operable to allow the subscriber to access a requested service if the quota is sufficient for the requested service; and
said apparatus is further operable to calculate a remaining credit for said account after the network transaction, and further operable to enforce a predetermined preventive action on the subscriber's subsequent network transactions if the remaining credit reaches a limit.

22. The apparatus of claim 21, wherein the apparatus is operable to update said PPS with the remaining credit upon receiving a second LEG notification indicating the subscriber logging out.

23. The apparatus of claim 21, wherein the remaining credit is maintained by said quota manager.

24. The apparatus of claim 22, wherein the first LEG notification and the second LEG notification are sent from an Authentication, Authorization and Accounting (AAA) server.

25. The apparatus of claim 23, wherein the service manager is operable to receive the first LEG notification and the second LEG notification.

26. The apparatus of claim 24, wherein at least one of the first LEG notification and the second LEG notification includes a subscriber identification number.

27. The apparatus of claim 21, wherein said predetermined preventive action comprises at least one of: blocking said network transaction, redirecting said network transaction and throttling said network transaction.

28. A method for charging a subscriber's prepaid network usage account in real time, the method comprising:
a) receiving a first login event generator (LEG) notification for the subscriber authentication;
b) obtaining a prepaid profile of the subscriber from a prepaid server;
c) mapping a new incoming subscriber network transaction to a requested service;
d) obtaining a quota for the prepaid usage account from the prepaid server;
e) allowing the subscriber to access the requested service if the quota is sufficient;
f) applying a first predetermined preventive action on the network transaction if the quota is not sufficient;
g) calculating a remaining credit for the prepaid usage account after the network transaction is completed;
h) if said remaining credit reaches a limit, applying a second predetermined preventing action on subsequent transaction networks.

29. The method of claim 28, said method further comprising:
i) updating the prepaid server with the remaining credit upon receiving a second LEG notification that notifies that the subscriber has logged out.

30. The method of claim 28, wherein the subscriber accesses the requested service using an IP capable terminal.

31. The method of claim 28, wherein the mapping of the transaction is followed by analyzing traffic flow for identifying the transaction.

32. The method of claim 31, wherein the transaction comprises a process flow.

33. The method of claim 32, wherein the process flow is identified by a unique process flow identification based on at least one of: source IP address, destination IP address, source port, destination port and protocol type.

34. The method of claim 33, wherein the process flow comprises packets flowing both upstream and downstream.

35. The method of claim 31, wherein the traffic flow is analyzed at wire-speed.

36. The method of claim 31, wherein said subscriber's network transaction is a billable action defined according to the requested service.

37. The method of claim 36, wherein said billable action is charged according to a predetermined rating function.

38. The method of claim 37, wherein said prepaid profile comprises a service that said subscriber is allowed to access.

39. The method of claim 38, wherein the service is one of: browsing, streaming, downloading, instance messaging, exchanging emails, gaming, voice over IP (VoIP) and peer-to-peer connection.

40. The method of claim 39, wherein the service is defined using a set of attributes and a set of measurement units.

41. The method of claim 40, wherein said attributes comprise at least one of: type of protocol type, application type, IP address, port name, hostname, universal resource locator (URL) and type of content.

42. The method of claim 41, wherein said protocol type comprises at least one of: hypertext transfer protocol (HTTP), file transfer protocol (FTP), wireless application protocol (WAP), post office protocol version 3 (POP3) and simple mail transfer protocol (SMTP).

43. The method of claim 40, wherein said measurement units comprise at least one of: volume of traffic, duration of a connection and allocated bandwidth.

44. The method of claim 41, wherein said mapping of the transaction further comprises checking if said requested service is defined in said prepaid profile.

45. The method of claim 44, wherein said mapping of the transaction is preceded by opening a network session with an IP capable terminal.

46. The method of claim 28, wherein the first and the second predetermined preventive action comprises at least one of blocking said network transaction, redirecting said network transaction and throttling said network transaction.

47. The method of claim 28, wherein the remaining credit is calculated at wire-speed.

48. The method of claim 47, wherein the remaining credit is calculated using a rating function.

49. The method of claim 29, wherein updating the prepaid server is preceded by closing the network session with the subscriber.

50. A computer program product, including computer-readable media with instructions to enable a computer to implement a method for performing over a network real-time charging of prepaid network usage accounts, the method comprising:
a) receiving a first login event generator notification for the subscriber authentication;
b) obtaining a prepaid profile of the subscriber from a prepaid server;
c) mapping a new incoming subscriber network transaction to a requested service;
d) obtaining a quota for the prepaid usage account from the prepaid server;
e) allowing the subscriber to access the requested service if the quota is sufficient;
f) applying a first predetermined preventive action on the network transaction if the quota is not sufficient;
g) calculating a remaining credit for the prepaid usage account after the network transaction is completed; and
h) if said remaining credit reaches a limit, applying a second predetermined preventing action on subsequent transaction networks.

51. The computer program product of claim 50, said methd further comprising:
i) updating the prepaid server with the remaining credit upon receiving a second LEG notification that notifies that the subscriber has logged out.

52. The computer program product of claim 50, wherein the subscriber accesses the requested service using an IP capable terminal.

53. The computer program product of claim 50, wherein the mapping of the transaction is followed by analyzing traffic flow for identifying the transaction.

54. The computer program product of claim 53, wherein the transaction comprises a process flow.

55. The computer program product of claim 54, wherein the process flow is identified by a unique process flow identification based on at least one of: source IP address, destination IP address, source port, destination port and protocol type.

56. The computer program product of claim 55, wherein the process flow comprises packets flowing both upstream and downstream.

57. The computer program product of claim 53, wherein the traffic flow is analyzed at wire-speed.

58. The computer program product of claim 53, wherein said subscriber's network transaction is a billable action defined according to the requested service.

59. The computer program product of claim 58, wherein said billable action is charged according to a predetermined rating function.

60. The computer program product of claim 59, wherein said prepaid profile comprises a service that said subscriber is allowed to access.

61. The computer program product of claim 60, wherein the service is one of: browsing, streaming, downloading, instance messaging, exchanging emails, gaming, voice over IP (VoIP) and peer-to-peer connection.

62. The computer program product of claim 61, wherein the service is defined using a set of attributes and a set of measurement units.

63. The computer program product of claim 62, wherein said attributes comprise at least one of: type of protocol type, application type, IP address, port name, hostname, universal resource locator (URL) and type of content.

64. The computer program product of claim 63, wherein said protocol type comprises at least one of: hypertext transfer protocol (HTTP), file transfer protocol (FTP), wireless application protocol (WAP), post office protocol version 3 (POP3) and simple mail transfer protocol (SMTP).

65. The computer program product of claim 62, wherein said measurement units comprise at least one of: volume of traffic, duration of a connection and allocated bandwidth.

66. The computer program product of claim 63, wherein said mapping of the transaction further comprises checking if said requested service is defined in said prepaid profile.

67. The computer program product of claim 66, wherein said mapping of the transaction is preceded by opening a network session with an IP capable terminal.

68. The computer program product of claim 50, wherein the first and the second predetermined preventive action comprises at least one of blocking said network transaction, redirecting said network transaction and throttling said network transaction.

69. The computer program product of claim 50, wherein the remaining credit is calculated at wire-speed.

70. The computer program product of claim 69, wherein the remaining credit is calculated using a rating function.

71. The computer program product of claim 51, wherein updating the prepaid server is preceded by closing the network session with the subscriber.
